(19) United States
(12) Patent Application Publication
(10) Pub. No.: US 2009/0194694 A1
(43) Pub. Date: Aug. 6, 2009

(54) Radiation detection apparatus and radiation image capturing system

(75) Inventors: Yasunori Ohta, Yokohama-shi (JP); Naoyuki Nishino, Minami-ashigara-shi (JP); Eiichi Kito, Minami-ashigara-shi (JP); Hiroshi Tamaoki, Odawara-shi (JP); Tatsuo Iiyama, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/320,579

(22) Filed: Jan. 29, 2009

(30) Foreign Application Priority Data
Feb. 1, 2008 (JP) 2008-022547

(51) Int. Cl. G01T 1/00

(52) U.S. Cl. 250/336.1

(57) ABSTRACT

A radiation detection apparatus including a casing, and a radiation detection device accommodated inside the casing, which detects radiation emitted from a radiation source and having passed through a subject, and converts the radiation into radiation image information, and an electronic circuit accommodated inside the casing, further comprising: storage device detachably mounted with respect to the casing, and wherein the electronic circuit includes a data compression circuit, which compresses the radiation image information, to thereby create compressed radiation image information, and herein the storage device stores the compressed radiation image information.

### BACKGROUND OF THE INVENTION

1. Field of the Invention

The present invention relates to a radiation detection apparatus for irradiating a subject with radiation and capturing a radiation image, as well as to a radiation image capturing system that uses such a radiation detection apparatus.

2. Description of the Related Art

In the medical field, a radiation image capturing apparatus, in which radiation is applied to a subject, and radiation that has passed through the subject is directed to a radiation detection device for capturing a radiation image of the subject, has been widely used.

In this case, as types of radiation detection devices, there are known a radiation film on which a radiation image is exposed and recorded, or a stimulable phosphor panel in which radiation energy is stored as a radiation image in a stimulable phosphor, and when stimulating light is applied thereto, the radiation image can be read out as stimulated light. In such radiation detection devices, the radiation film in which the radiation image has been recorded is supplied to a developing apparatus where an image developing process is carried out, or the stimulable phosphor panel is supplied to a reading apparatus in which the radiation image is acquired as a visible image by performing a reading process thereon.

On the other hand, in a medical environment such as an operating room or the like, for performing rapid and precise treatments with respect to a patient, it is essential to read out and display the radiation image directly from the radiation detection device. As a radiation detection device capable of responding to such requirements, a radiation detection device has been developed that uses solid state detection elements which convert radiation directly into electrical signals, or which, after the radiation has been converted into visible light by a scintillator, converts the visible light into electrical signals, which are read out.

In addition, heretofore, various data transmitting methods for transmitting radiation image information to the exterior from a radiation detection device using solid state detecting elements have been proposed. (See, Japanese Laid-Open Patent Publication No. 2004-101195, Japanese Laid-Open Patent Publication No. 2005-296050, Japanese Laid-Open Patent Publication No. 2002-190584 and Japanese Laid-Open Patent Publication No. 2006-267043.)

In the method disclosed in Japanese Laid-Open Patent Publication No. 2004-101195, image data detected by solid state detecting elements is subjected to thinning processing, converted to wireless signals, and transmitted to the exterior. In the method disclosed in Japanese Laid-Open Patent Publication No. 2005-296050, image data detected by solid state detecting elements is subjected to data compression, and is transmitted to and displayed on a display device through a wireless antenna for enabling confirmation. In Japanese Laid-Open Patent Publication No. 2002-190584, image data from an electronic cassette is recorded in a recording medium, whereupon the image data is read out from the recording medium and supplied to a storage server or the like. In the method disclosed in Japanese Laid-Open Patent Publication No. 2006-267043, radiation image data recorded in a radiation detection device is stored in a detachable image memory, which is then moved to an external apparatus.

However, in the methods disclosed in Japanese Laid-Open Patent Publication No. 2004-101195 and Japanese Laid-Open Patent Publication No. 2005-296050, due to the influence of electromagnetic waves between the electronic cassette and the external apparatus, problems may be caused in particular with respect to sensitive equipment related to medical procedures.

In the methods disclosed in Japanese Laid-Open Patent Publication No. 2002-190584 and Japanese Laid-Open Patent Publication No. 2006-267043, problems related to electromagnetic waves can be avoided. However, a large capacity recording medium is needed, leading to an increase in costs. There is also a problem in that the image data cannot be stored quickly in the recording medium.

### SUMMARY OF THE INVENTION

The present invention, taking into consideration the above-mentioned problems, has the object of providing a radiation detection apparatus and radiation image capturing system, in which adverse effects of electromagnetic radiation are not incurred, and required image information can be swiftly acquired and confirmed.

A radiation detection apparatus in accordance with a first aspect of the present invention includes a casing, with a radiation detection device accommodated inside the casing, which detects radiation emitted from a radiation source and having passed through a subject, and converts the radiation into radiation image information, and an electronic circuit accommodated inside the casing. The radiation detection apparatus further has a storage device detachably mounted with respect to the casing, and the electronic circuit includes a data compression circuit therein, which compresses the radiation image information to thereby create compressed radiation image information, wherein the storage device stores the compressed radiation image information.

A radiation image capturing system in accordance with a second aspect of the present invention has a radiation detection apparatus that includes a casing, with a radiation detection device accommodated inside the casing, which detects radiation emitted from a radiation source and having passed through a subject, and converts the radiation into radiation image information, and an electronic circuit accommodated inside the casing. The electronic circuit of the radiation detection apparatus includes a data compression circuit therein, which compresses the radiation image information to thereby create compressed radiation image information. The radiation image capturing system further includes a storage device detachably mounted with respect to the casing of the radiation detection apparatus and in which the compressed radiation image information is stored, and a display device into which the storage device can be loaded when detached from the casing of the radiation detection apparatus, for displaying the compressed radiation image information stored in the storage device.

According to the present invention, the adverse influence of electromagnetic waves is not imparted to the system, and necessary image information can be quickly acquired and confirmed.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a structural view showing a radiation image capturing system;

FIG. 2 is an interior structural view of an electronic cassette;

FIG. 3 is a block diagram of a circuit structure of a radiation detection device accommodated inside the electronic cassette;

FIG. 4 is a schematic block diagram showing primarily the cassette controller of the electronic cassette; and

FIG. 5 is a schematic block diagram of the radiation image capturing system.

### DESCRIPTION OF THE PREFERRED EMBODIMENTS

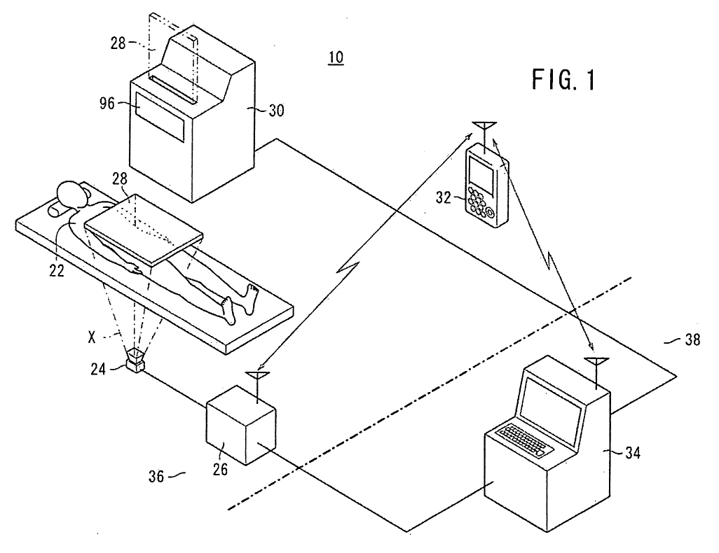

A radiation detection device and a radiation image capturing system in accordance with embodiments of the present invention shall be described below with reference to FIGS. 1 through 5.

As shown in FIG. 1, the radiation image capturing system 10 according to the present embodiment is equipped with a radiation source 24 for irradiating a patient 22 (subject) with radiation X having a given dose according to image capturing conditions, a radiation source controller 26 for controlling the radiation source 24, a radiation detection apparatus (hereinafter referred to as an electronic cassette 28) containing a radiation detection device 44 that detects radiation X having passed through the patient 22, a cradle 30 for carrying out a charging process on the electronic cassette 28, a portable information terminal 32 having an image capturing switch for activating the radiation source 24, which is carried by a technician for confirming conditions including image capturing operations, and a console 34 (control device) for controlling the radiation source controller 26, the electronic cassette 28, the cradle 30 and the portable information terminal 32, as well as performing transmission and reception of necessary information therebetween.

The radiation source 24, the radiation source controller 26 and the cradle 30 are disposed inside an image capturing room 36, whereas the console 34 is located in an operations room 38 outside of the image capturing room. Further, necessary information may be transmitted and received between the radiation source controller 26, the portable information terminal 32 and the console 34 by means of wireless communications.

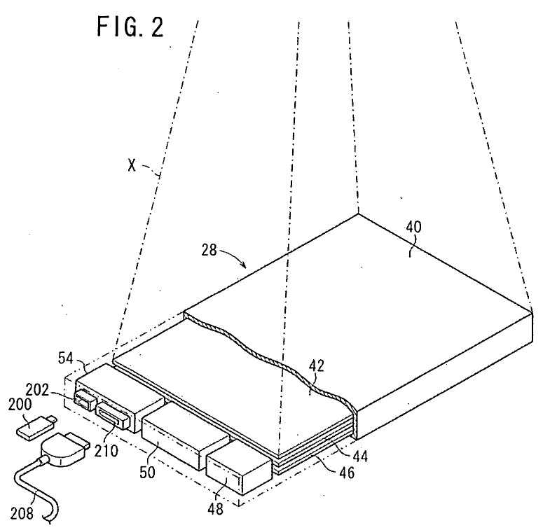

The electronic cassette 28, as shown in FIG. 2, is equipped with a casing 40 made from a material which is permeable to radiation X. Inside of the casing 40, a grid 42 for removing radiation X scattered by the patient 22, a radiation detection device 44 (solid state detector) for detecting radiation X that have passed through the patient 22, and a lead plate 46 for absorbing backscattered radiation X are arranged in this order from a side surface on which radiation X is irradiated.

Further, a battery 48, which serves as a power source for the electronic cassette 28, a cassette controller 50 that controls driving of the radiation detection device 44, an image memory 52 for recording therein image information (radiation image information) of radiation X that has been detected by the radiation detection device 44, and an interface 54 are accommodated in the casing 40, respectively. Moreover, in order to avoid damage caused by radiation X to the electronic circuits of the cassette controller 50, the image memory 52 and the interface 54, etc., it is preferable for a lead plate or the like to be disposed on surface sides of the casing 40 that are subject to being irradiated with radiation X.

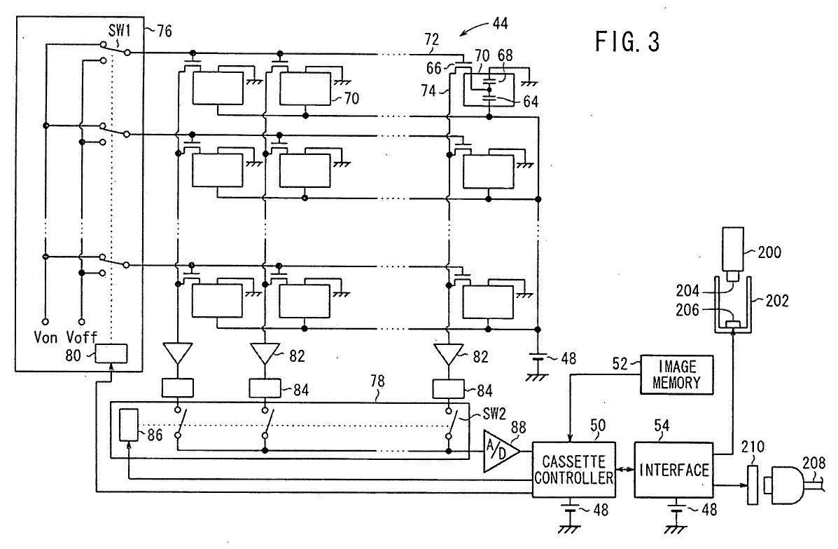

As shown in FIG. 2, on one side surface of the casing 40, a slot 202 is provided for detachably mounting a memory card 200 (storage device). Inside the slot, as shown in FIG. 3, a first connection terminal 206 is arranged, to which the external terminal 204 of the memory card 200 is connected. The first connection terminal 206 is connected to the interface 54. As the memory card, for example, a USB memory or the like, various types of which are available on the market, can be used.

Further, on the side surface of the casing 40, a second connection terminal 210 is arranged, to which a cable 208 for connection to the console 34 may be attached. The second connection terminal 210 also is connected to the interface 54.

As shown in FIG. 3, the radiation detection device 44 includes a structure in which a photoelectric conversion layer 64 made up from an amorphous selenium (a-Se) material, which generates electric charges upon sensing radiation X, is disposed on thin film transistors (TFTs) 66 arrayed in a matrix form. After the generated electric charges are accumulated in storage capacitors 68, the TFTs 66 are successively turned on one line at a time, and the electric charges are read out as image signals. FIG. 3 shows the connected relationship of only one of the TFTs 66 and one pixel (image element) 70 made up from a photoelectric conversion layer 64 and a storage capacitor 68, whereas the structures of other similar pixels 70 have been omitted from illustration for the sake of simplicity. Since when heated to high temperatures, the structure of amorphous selenium changes and the functionality thereof is lowered, amorphous selenium must be used within a prescribed temperature range. Accordingly, it is preferable to provide some means for cooling the radiation detection device 44 inside the electronic cassette 28.

Gate lines 72, which extend in parallel to the direction of the rows, and signal lines 74 which extend in parallel to the direction of the columns, are connected to the TFTs 66, which are connected respectively to each of the pixels 70. Each of the gate lines 72 is connected to a line scanning driver 76, and each of the signal lines 74 is connected to a multiplexer 78 that constitutes a reading circuit.

Control signals V_{ON}, V_{OFF} that control ON and OFF states of the TFTs 66 arrayed in the direction of the rows, are supplied from the line scanning driver 76 to the gate lines 72. In this case, the line scanning driver 76 comprises a plurality of switches SW1 that switch the gate lines 72 on or off, and a first address decoder 80, which outputs selection signals for selecting one of the switches SW1. Address signals are supplied from the cassette controller 50 to the first address decoder 80.

Further, the signal lines 74 are supplied with electric charges, which are stored in the storage capacitors 68 of each of the pixels 70, through the TFTs 66 arranged in the columns. The electric charges supplied to the signal lines 74 are amplified by amplifiers 82. The amplifiers 82 are connected through respective sample and hold circuits 84 to the multiplexer 78. The multiplexer 78 comprises a plurality of switches SW2 for successively switching between the signal lines 74, and a second address decoder 86 for outputting a selection signal for selecting one of the switches SW2 at a time. The second address decoder 86 is supplied with an address signal from the cassette controller 50. An A/D converter 88 is connected to the multiplexer 78. A radiation image signal is converted by the A/D converter 88 into a digital image signal representing the radiation image information, which is supplied to the cassette controller 50.

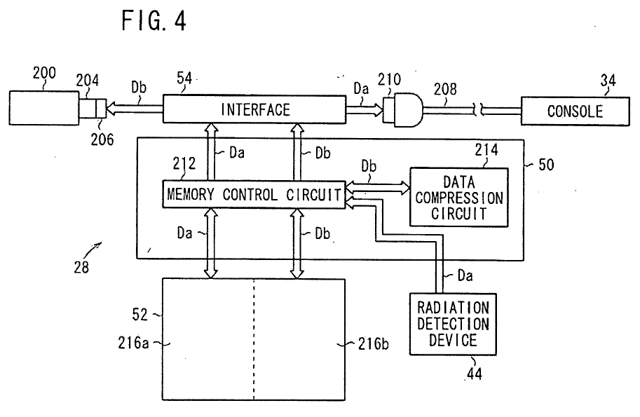

As shown in FIG. 4, the cassette controller 50 includes a memory control circuit 212 and a data compression circuit 214. The memory control circuit 212 carries out the following processes.

(1) Storing “as is” in a first storage region 216a of the image memory 52 the radiation image information Da supplied to the cassette controller 50 from the radiation detection device 44; and

(2) Supplying the radiation image information Da supplied to the cassette controller 50 to the data compression circuit 214, subjecting the radiation image information Da to data compression processing and creating compressed radiation image information Db, and storing the compressed radiation image information Db in a second storage region 216b of the image memory 52.

The radiation image data Da stored in the first storage region 216a of the image memory 52 is supplied to the second connection terminal 210 through the interface 54 under the control of the cassette controller 50, and is transmitted to the console 34 through the cable 208 connected to the second connection terminal 210. Accordingly, data transmission of the radiation image information Da to the console 34 is carried out at a stage when the cable 208 is connected to the electronic cassette 28.

On the other hand, the compressed radiation image information Db stored in the second storage region 216b of the image memory 52 is supplied to the first connection terminal 206 through the interface 54 under the control of the cassette controller 50, and is transmitted to and stored in the memory card 200, which is attached to the first connection terminal 206 of the slot 202.

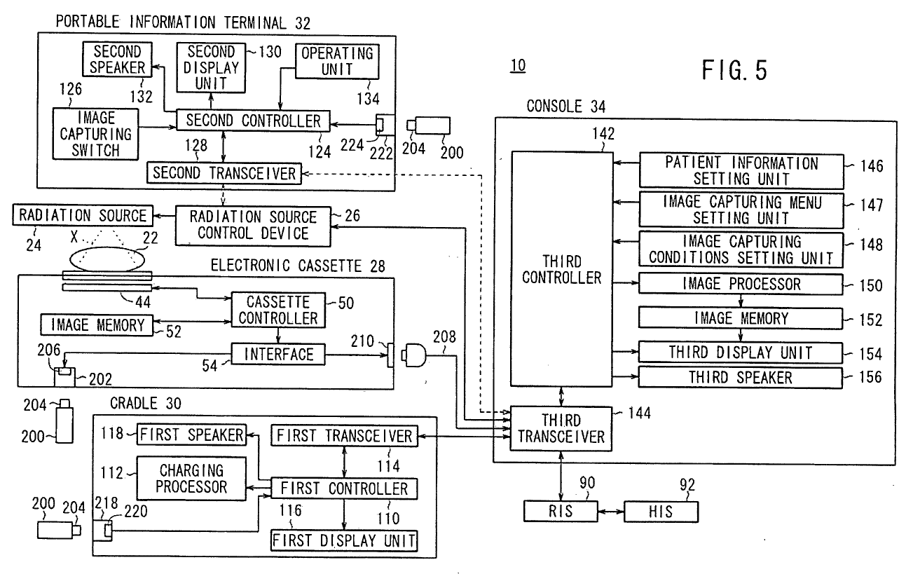

FIG. 5 is a schematic block diagram of the radiation image capturing system 10. The console 34 is connected to a radiology information system (RIS) 90, which generally manages radiation image information handled by the radiological department of a hospital along with other information. Further, the RIS 90 is connected to a hospital information system (HIS) 92, which generally manages medical information in the hospital.

A first controller 110 of the cradle 30 controls a charging processor 112 that carries out a charging process on the battery 48 of the electronic cassette 28. Information received from the console 34 through a first transceiver 114 is displayed on a first display unit 116, and as needed, information may be audibly output by a first speaker 118.

Further, a first slot 218 is provided on the cradle 30, in which the memory card 200 can be detachably mounted. Inside the first slot 218, a connection terminal 220 is arranged, to which the external terminal 204 of the memory card 200 is connected. The connection terminal 220 is connected to the first controller 110 through a non-illustrated interface. Accordingly, when the memory card 200 is mounted in the first slot 218, the first controller 110 acquires the compressed radiation image information Db stored in the memory card 200, and displays the image information as a preview image on the first display unit 116.

Further, a second controller 124 of the portable information terminal 32 supplies the radiation source controller 26 through a second transceiver 128 with an image capturing signal generated by the image capturing switch 126 that drives the radiation source 24. The second controller 124 causes information received from the console 34 through the second transceiver 128 to be displayed on a second display unit 130, and as needed, causes the information to be output audibly by a second speaker 132. The portable information terminal 32 includes an operating unit 134, through which various required information can be set.

Further, a second slot 222 is provided in the portable information terminal 32, in which the memory card 200 can be detachably mounted. Inside the second slot 222, a connection terminal 224 is arranged, to which the external terminal 204 of the memory card 200 is connected. The connection terminal 224 is connected to the second controller 124 through a non-illustrated interface. Accordingly, when the memory card 200 is mounted in the second slot 222, the second controller 124 acquires the compressed radiation image information Db stored in the memory card 200, and displays the compressed radiation image information Db as a preview image on the second display unit 130.

The console 34 includes a third controller 142, a third transceiver 144 for transmitting and receiving necessary information by wireless communications with respect to the radiation source controller 26, and the portable information terminal 32, a patient information setting unit 146 for setting patient information, an image capturing menu setting unit 147 for selecting and setting from an image capturing menu a region to be imaged of the patient 22, an image capturing conditions setting unit 148 for setting required image capturing conditions for capturing an image by the radiation source controller 26, an image processor 150 for carrying out image processing with respect to radiation image information transmitted as data from the electronic cassette 28, an image memory 152 for storing the processed radiation image information, a third display device 154 for displaying the radiation image information, patient information, the image capturing menu, and the like, and a third speaker 156 for audibly outputting warnings when necessary.

The patient information is defined as information for specifying a patient 22, such as the name and sex of the patient 22, a patient ID number, and the like. The image capturing menu serves as a menu for selecting an image capturing region of the patient 22. As an image capturing region, the head region, a chest region, or regions of the four limbs, etc., may be considered. The image capturing conditions are conditions for determining a supplied tube voltage, tube current, irradiation time, etc., for irradiating an imaging region of the patient 22 with an appropriate dose of radiation X. The patient information and image capturing operating information, including the imaging capturing menu and the image capturing conditions, can be set by the console 34, or can be supplied externally to the console 34 through the RIS 90.

The radiation image capturing system 10 is basically constructed as described above. Next, operations of the radiation image capturing system 10 shall be described.

When a radiation image is to be captured of the patient 22, using the patient information setting unit 146 of the console 34, patient information concerning the patient 22 is set, together with setting required image capturing conditions using the image capturing conditions setting unit 148. Further, using the image capturing menu setting unit 147, a desired image capturing region, for example, the head region, a chest region, or a region of the four limbs, etc., is set from the image capturing menu shown on the third display device 154.

The set patient information, image capturing conditions and image capturing region are transmitted to the portable information terminal 32 held by the technician and displayed on the second display unit 130 thereof. In this case, the technician confirms the patient information, the image capturing conditions and the image capturing region, which are displayed on the second display unit 130 of the portable information terminal 32, so that desired preparations for capturing the image can be carried out.

Next, the technician mounts the memory card 200 in the electronic cassette 28 through the slot 202 thereof. In this condition, the electronic cassette 28 is placed at the desired image capturing region on the patient, which was selected from the image capturing menu. Of course, the memory card 200 may also be mounted after the electronic cassette 28 has been placed at the desired image capturing region.

Once the electronic cassette 28 has been placed in an appropriate state with respect to the patient 22, the technician operates the image capturing switch 126 of the portable information terminal 32 in order to carry out capturing of the radiation image. When the image capturing switch 126 is operated, the second controller 124 of the portable information terminal 32 transmits an image capturing initiation signal to the radiation source controller 26 via the second transceiver 128. The radiation source controller 26, which has received the image capturing initiation signal, controls the radiation source 24 according to the image capturing conditions supplied beforehand from the console 34, and thereby irradiates the patient 22 with radiation X.

Radiation X that has passed through the patient 22, after scattered rays have been removed by the grid 42 of the electronic cassette 28, irradiates the radiation detection device 44 and is converted into electric signals by the photoelectric conversion layer 64 of each of the pixels 70 making up the radiation detection device 44, which are retained as charges in the storage capacitors 68 (see FIG. 3). Next, the electric charge information that forms the radiation image information of the patient 22 stored in each of the storage capacitors 68 is read out in accordance with address signals, which are supplied from the cassette controller 50 to the line scanning driver 76 and the multiplexer 78.

More specifically, the first address decoder 80 of the line scanning driver 76 outputs a selection signal based on the address signal supplied from the cassette controller 50, thereby selecting one of the switches SW1, and supplies a control signal VON to the gate of the TFT 66 that is connected to a corresponding gate line 72. On the other hand, the second address decoder 86 of the multiplexer 78 outputs a selection signal according to the address signal supplied from the cassette controller 50, and successively switches the switches SW2, whereby the radiation image information, which is formed as electric charge information stored in the storage capacitors 68 of each of the pixels (image elements) 70 that are connected to the gate line 72 selected by the line scanning driver 76, is read out in succession through the signal lines 74.

After the radiation image information read from the storage capacitors 68 of the pixels 70 connected to the selected gate line 72 of the radiation detection device 44 has been amplified by the respective amplifiers 82, the radiation image information is sampled by each of the sample and hold circuits 84, and supplied to the A/D converter 88 through the multiplexer 78 and converted into digital signals. The radiation image information Da having been converted into digital signals is stored in the first storage region 216a of the image memory 52 by the memory control circuit 212 of the cassette controller 50. Furthermore, the radiation image information Da is subjected to data compression by the memory control circuit 212 and the data compression circuit 214, and is stored as compressed radiation image information Db in the second storage region 216b of the image memory 52.

Similarly, the first address decoder 80 of the line scanning driver 76 successively turns on the switches SW1 according to the address signals supplied from the cassette controller 50, and reads out the radiation image information Da, which is made up of charge information stored in the storage capacitors 68 of each of the pixels 70 connected respectively to the gate lines 72, whereupon the radiation image information Da is stored in the first storage region 216a of the image memory 52 through the multiplexer 78 and the A/D converter 88. Furthermore, the compressed radiation image information Db therefrom is stored in the second storage region 216b.

The compressed radiation image information Db stored in the second storage region 216b of the image memory 52 is stored in the memory card 200 through the cassette controller 50 and the interface 54. Accordingly, at a stage after the image has been captured, the technician takes out the memory card 200 at once from the slot 202 and mounts the memory card 200 in the second slot 222 of the portable information terminal 32, whereby the compressed radiation image information Db is displayed as a preview image on the second display unit 130. Alternatively, the memory card 200 may be mounted in the first slot 218 of the cradle 30, whereby the compressed radiation image information Db is displayed as a preview image on the first display unit 116.

The technician can confirm the compressed radiation information Db displayed on the first display unit 116 or the second display unit 130, and thereby can determine whether recapturing of the radiation image is necessary or not. In particular, because the amount of information is reduced due to data compression, the compressed radiation image information Db can be displayed quickly.

The radiation image information Da stored in the first storage region 216a of the image memory 52 is transmitted as data to the console 34 through the cassette controller 50 and the interface 54, at a stage when the electronic cassette 28 is connected to the console 34 through the cable 208. After image processing has been implemented by the image processor 150 on the radiation image information Da, which has been transmitted as data to the console 34, the radiation image information Da is stored in the image memory 152 of the console 34 in a state of association with the patient information. Subsequently, the radiation image information Da stored in the image memory 152 is displayed on the third display device 154.

In the electronic cassette 28, for which an image capturing process has been carried out, the battery 48 thereof is consumed. In this case, the electronic cassette 28 is loaded into the cradle 30 so that a charging process can be performed with respect to the battery 48.

In this manner, in the radiation image capturing system 10, the radiation image information Da acquired by the electronic cassette 28 is subjected to data compression and stored in the memory card 200. Since the memory card 200 is loaded into the cradle 30 or the portable information terminal 32 and an image is displayed thereby, any influence of electromagnetic waves is not incurred, and necessary radiation image information can be acquired and confirmed swiftly.

In the above-mentioned example, the battery 48 is accommodated inside the casing 40 of the electronic cassette 28, so that power is supplied to the radiation detection device 44 and the electronic circuits from the battery 48. However, apart from this technique, electrical power may also be supplied to the radiation detection device 44 and electronic circuits of the electronic cassette 28 from the exterior through a cable, without requiring the battery 48 to be accommodated within the casing 40. In this case, the electronic cassette 28 can be made lighter in weight.

Of course, the present invention is not limited to the above-described embodiments, and the invention can be freely modified, within a range that does not deviate from the essence and gist of the present invention.

For example, the radiation detection device 44 accommodated in the electronic cassette 28 converts the dose of the irradiated radiation X directly into electric signals through the photoelectric conversion layer 64 (direct conversion type). However, in place of this structure, a radiation detection device in which irradiated radiation X is converted initially into visible light by a scintillator, and thereafter, the visible light is converted into electric signals using a solid-state detector element formed from amorphous silicon (a-Si) or the like (indirect conversion type), may also be used (see, Japanese Patent No. 3494683).

Further, the radiation image information can be obtained using a light readout type of radiation detection device. With such a light readout type of radiation detection device, radiation is irradiated onto respective solid state detection elements arranged in a matrix form, and an electrostatic latent image corresponding to the irradiation dose is stored cumulatively in the solid state detection elements. When the electrostatic latent image is read, reading light is irradiated onto the radiation detection device, and the generated current values are acquired as radiation image information. Further, by irradiating the radiation detection device with erasing light, the radiation image information in the form of a residual electrostatic latent image can be erased and the radiation detection device can be reused (see, Japanese Laid-Open Patent Publication No. 2000-105297).

Furthermore, a stimulable phosphor panel can also be used as the radiation detection device.

What is claimed is:

1. A radiation detection apparatus including a casing, and a radiation detection device accommodated inside the casing, which detects radiation emitted from a radiation source and having passed through a subject, and converts the radiation into radiation image information, and an electronic circuit accommodated inside the casing, further comprising:
a storage device detachably mounted with respect to the casing, and wherein
the electronic circuit includes a data compression circuit, which compresses the radiation image information, to thereby create compressed radiation image information, and
wherein the storage device stores the compressed radiation image information.

2. A radiation image capturing system having a radiation detection apparatus including a casing, and a radiation detection device accommodated inside the casing, which detects radiation emitted from a radiation source and having passed through a subject, and converts the radiation into radiation image information, and an electronic circuit accommodated inside the casing,
the electronic circuit of the radiation detection apparatus including a data compression circuit, which compresses the radiation image information, to thereby create compressed radiation image information, and further comprising:
a storage device detachably mounted with respect to the casing of the radiation detection apparatus, and in which the compressed radiation image information is stored; and
a display device in which the storage device is loaded when detached from the casing of the radiation detection apparatus, for displaying the compressed radiation image information stored in the storage device.

3. The radiation image capturing system according to claim 2, wherein:
in the radiation detection apparatus, a battery for supplying power at least to the radiation detection device and the electronic circuit is accommodated inside the casing;
the display device is disposed on a cradle, which carries out charging with respect to at least the battery by mounting of the radiation detection apparatus in the cradle; and
the storage device is capable of being detachably connected to the cradle.

4. The radiation image capturing system according to claim 2, wherein:
the display device is disposed on a portable information terminal, which is carried by a user; and
the storage device is capable of being detachably connected to the portable information terminal.
